(19) United States
(12) Patent Application Publication
(10) Pub. No.: US 2010/0101916 A1
(43) Pub. Date: Apr. 29, 2010

(54) DEVICE FOR PROCESSING FLAT PRODUCTS AND METHOD FOR OPERATING SAID DEVICE

(75) Inventor: Werner Honegger, Bach (CH)

Correspondence Address: RANKIN, HILL & CLARK LLP, 38210 Glenn Avenue, WILLOUGHBY, OH, 44094-7808, US

(73) Assignee: FERAG AG, Hinwil (CH)

(21) Appl. No.: 12/593,474

(22) PCT Filed: Dec. 10, 2007
(86) PCT No.: PCT/CH07/00616

§ 371 Date: Oct. 12, 2009

(30) Foreign Application Priority Data
Mar. 28, 2007 (CH) 497/07

(51) Int. Cl. B65G 47/00

(52) U.S. Cl. 198/339.1

(57) ABSTRACT

The invention relates to a device for processing flat products (30), particularly printing products, and to a corresponding operating method. The device comprises at least one lever (10), which carries a processing element (20) and can be moved along a closed path of movement (B) located in a movement plane (E) by a driving member (1). The lever (10) is pivotally controlled about a first pivoting axis (S1) that runs perpendicular to the movement plane (E) such that it is oriented in a first partial region (B1) of the path of movement (B) in relation thereto to the outside and in a second partial region (B2) of the path of movement (B) in relation thereto to the inside, in order to prevent projecting of the levers (10) and to implement a spatially compact device. Due to the lever (1) being inclined at least in the second partial region (B2) of the path of movement (B) in relation to the movement plane (E), the use of relatively long levers (10) is made possible in spite of the compact design, without the levers mechanically interfering with each other along the path of movement. The device is particularly suitable for opening folded printing products. A use for other purposes is also possible.

### BACKGROUND OF THE INVENTION

1. Field of the Invention

The invention relates to a device for processing flat products and to a method for the operation of such a device. The invention, in particular, may be applied for processing printed products, e.g. for opening folded printed products or for lettering, labeling, depositing glue, gluing-on accompanying products, gripping, suctioning individual products or for welding a continuous material web.

2. Description of Related Art

Devices for processing flat products, with which at least one processing element coupled via a lever to a drive member is movable along a closed movement path lying in a movement plane are known from a variety of publications. For example, CH 632719 discloses a device for opening multi-paged paper products, with which opening elements are articulated on radially directed continuations of wheels via radially outwardly directed pivotable levers. The continuations, and thus the levers, with the processing elements engage in a gear-like manner into compartments of a star feeder, in which the products are located. Thereby, they lie on the outer product part and press this against the compartment wall. By way of rotating the wheels, a relative movement between the processing element and the compartment wall and thus between the individual pages of the product is effected, which leads to a squashing and bending up of part of the printed product. The levers are pivotable relative to the wheel within a small angle region about a pivot axis running parallel to the rotation axis of the wheel. With this device however, an insertion of the processing elements is only possible into the front region of the compartments, so that only the product edge which is distant to the rotation axis of the star feeder and which points to the outside, is accessible for the processing with this device. Shorter formats may not be processed at all.

The processing device according to EP-A 0 540 865, which serves for gluing supplements to printed products, is constructed in a similar manner. Here too, the levers always point radially outwards with respect to a drive wheel. They may, however, be extended to different extents in the radial direction by way of pivoting, in order to grip folded products which lie on radially arranged saddles of a conveyor wheel. Here too, one may only access those products which lie in the proximity of the saddle back.

The processing device according to EP-A 1 275 607 likewise serves for gluing supplements to printed products and is constructed similarly to the devices described above. Hereby, the processing elements themselves are pivotably attached on the pivotable lever. Their pivot position is controlled such that despite an arcuate revolving path, the processing elements in the processing region are always orientated perpendicularly with respect to the products to be glued, i.e. immerse parallel to the product alignment, in each case between two products. In the rearward region of the revolving path, the processing elements, given a constant radial orientation of the levers, are pivoted into a position orientated tangentially to the revolving path, in order to be able to withdraw the supplements from a supply roll. Further devices which in principle function in a similar manner, are known from EP-A 0 570 339, EP 1 112 861 and EP-A 0 606 550.

A processing device serving for welding a material web, with two cooperating part devices constructed similarly to the devices described above, is known from WO-A 00/35757. The part devices in each case comprise a processing element, which is attached to a spoke rotatable about a rotation axis, via a short, pivotable lever. The lever is controlled such that its orientation in space always remains the same, specifically perpendicularly to the material web to be processed. A perpendicular action in the region of processing is made possible by way of this. The complete length of the lever, including the processing element, is significantly shorter than the length of the spoke.

With all described devices, the achievable processing position of the processing element relative to the product to be processed, i.e. the maximal possible distance of the processing element to the front edge of the product, which faces the device, is dependent on which part of the revolving path of the processing elements is accessible to the products without mechanical interference and on which displacement the processing elements must carry out relative to the products in this freely accessible part of the movement path.

With the described devices, the travel (displacement) or the possible processing position is given by the length of the lever. This is small in relation to the radius of the drive member, and may not be infinitely increased for various reasons. With those devices, with which the lever always projects outwards, the complete device on extending the lever has a greatly increased spatial requirement, which is often not desired. A folding-away of the lever in the tangential direction, such as e.g. with EP-A 0 606 550 or EP-A 0 570 339, is only possible without spatial hindrance of the adjacent levers, if the distances of the pivot axes of the levers along their movement path are larger than the lever lengths. For the same reason, it is only possible to leave their orientation in space approximately constant, as with WO-A 00/35757, with relatively short levers.

It is therefore the object of the invention to specify a device for processing flat products, which despite a low spatial requirement, permits a relatively large travel and thus a defined processing depth.

### BRIEF SUMMARY OF THE INVENTION

The device according to the invention includes at least one lever which carries a processing element and may be moved by a drive member along a closed movement path lying in a movement plane. The lever is pivotable in a controlled manner about a pivot axis running perpendicularly to the movement plane. A lever is a mechanical connection between the processing element and the drive member, by way of which a certain, as a rule (but not necessarily) constant distance of the processing element to the pivot axis is created. The lever may also be an integral component of the processing element. The path of the first pivot axis of the lever may be seen as the movement path. As with WO-A 00/35757, the lever in a first part region of the movement path is orientated to the outside with respect to this movement path, and in a second part region of the movement path is orientated inwards with respect to this movement path. This means that the lever arm leading to the processing element, in the first part region, is arranged outside the region enclosed by the movement path, and in the second part region is completely within, or with very long levers, also only partly within, the region enclosed by the movement path. According to the invention, the at least one lever, at least in the second part region of the movement path, is inclined relative to the movement plane. The levers are thus fastened such that their lever arm or at least part a thereof assumes an angle to the movement plane which differs from zero. The levers may be straight, but also e.g. cranked, bent at an angle or bent. The levers may also run parallel again to the movement plane in a region which is distanced further from the first pivot axis.

The invention permits the application of levers which are long in comparison to the smallest radius of curvature of the path or—with several levers—in comparison to the mutual distance. With several levers, a mechanical interference of the levers or processing elements amongst one another is ruled out due to the inclination relative to the movement plane. With only one lever, one advantageously prevents this from dragging on the drive member. In the normal case, the levers are rotatable about the first pivot axis, i.e. about 360°, in order to carry out the described change in orientation with respect to the movement path, during a revolving along the movement path. With several levers, thanks to the inclination, a synchronous rotation about the first pivot axis is possible without mutual mechanical interference with one another.

In a first part region of the movement path, the levers and, thus, the processing elements are orientated outwards with respect to the movement path. This part region or sections thereof may be utilised as a processing region for processing products which are conveyed past the device, preferably with roughly the same conveying speed and conveying direction as the (momentary) movement direction and speed of the processing elements. The second part region of the movement path serves for the space-saving return feed of the processing elements into the processing region.

By way of the invention, one succeeds in freely selecting the lever lengths, so that the complete travel, which would theoretically be possible on account of the distance change of the movement path relative to the products to be processed, may also indeed be practically used. The spatial extension of the device in a plan view of the movement plane in the second part region of the movement path corresponds essentially to only that area which is enclosed by the movement path. In the first part region, the levers and the processing elements, of course, project beyond this area, in order to carry out the desired processing.

In one advantageous variant of the invention, the drive member comprises a rigid body which is rotatable about a rotation axis, for example a wheel or at least one spoke. The at least one lever is connected to this in a pivotable manner at a constant distance to the rotation axis, preferably by 360°, in particular in the outer edge region of the body which is distant to the rotation axis. The movement path of the first pivot axes is therefore a circle. If the orientation of the levers in space does not change, the processing elements likewise describe a circular path with the same radius. If the lever length corresponds to this radius or is larger, the processing elements at least over half of the movement path are freely accessible and thereby execute a travel, which corresponds to the radius and with a complete release maximally corresponds to the diameter of the movement path. This is a significant improvement to the known devices with levers articulated on a wheel or spokes, with which only a travel of the magnitude of the lever length, which is significantly smaller compared to the radius, may be achieved.

The invention may advantageously be applied with other drive types, in particular in combination with a rail-led conveyor system. The processing elements are hereby, for example, connected via levers to transport means, which are movable individually or combined by way of coupling to a suitable drive member, along guide rails, or in another suitable manner along a defined movement path. By way of the levers being inclined relative to the movement plane, here too they may be designed comparatively long, and despite this may be pivoted or rotated relative to the transport means without mutual, mechanical hindrance or interference. Thus, in the processing region, one may realise a larger travel of the processing elements, whilst the levers are otherwise located within that region which is delimited by the movement path.

The device according to the invention is particularly preferably applied for opening folded printed products. For opening, it is often desirable for the opening element to be able to engage deep into the machine, e.g. in pockets or conveyor compartments for the folded product, for example in order to also be able to process smaller formats. The processing element for this is preferably an opening blade.

Other processing elements, for example, are gripper members or suction elements for transporting a supplementary product which is to be added to the printed product, e.g. by way of insertion and/or gluing on. The processing element may also comprise a welding element for welding a protective film, or an injection nozzle, which for example may serve for depositing ink or glue. The device may also be applied for the mere conveying of a flat product with a gripper or sucker, without any additional processing.

Additionally to the pivoting ability about the first pivot axis, the levers may be pivotable about a further pivot axis, which lies in or parallel to the movement plane. In the first part region of the movement path or in the processing region, one may additionally achieve a movement of the processing element perpendicularly to the movement plane by way of this, for example in order, by way of pivoting the lever into the movement plane, to plunge into a product from the side. In the second part region, the levers are pivoted out of the movement plane again, in order to be able to move them along the movement path without mutual mechanical restriction.

The levers with the processing elements may also be mounted on both sides on two wheels or other carrier members. By way of this, one succeeds in the processing elements being able to have a certain extension perpendicular to the movement plane and despite this being mounted and supported in a stable manner. The processing elements may, for example, comprise carrier beams orientated perpendicularly to the movement plane.

The orientation of the levers relative to the movement path and, as the case may be, the pivot position relative to the movement plane, is preferably controlled in each case with a control cam, which cooperates with the levers, e.g. runner rollers arranged thereon. The control cam in each case may act on the levers over the complete movement path or only in sections thereof. The desired orientation and/or pivot position may e.g. be supported by gravity and/or be assumed on account of spring bias, e.g. in sections which are not controlled.

### BRIEF DESCRIPTION OF THE DRAWINGS

Examples of the invention are represented in the drawings and are described hereinafter. The figures show purely schematically:

FIGS. 1 and 2 a basic sketch of a device according to the invention with a wheel as a drive, in a view onto the movement plane, and in section perpendicularly to the movement plane;

FIG. 3 a basic sketch of a further device according to the invention, with a revolving conveyor member as a drive, in a view on the movement plane;

FIG. 4 the immersion of a processing element into an opened printed product;

FIGS. 5 and 6 an opening device according to the invention, with a wheel as a drive, in a view onto the movement plane, and in a section perpendicular to the movement plane;

FIG. 7 a detailed view of an opening element;

FIGS. 8 and 9 detailed views of a lever of a further opening device according to the invention, said lever being pivotable about two axes.

### DETAILED DESCRIPTION OF THE INVENTION

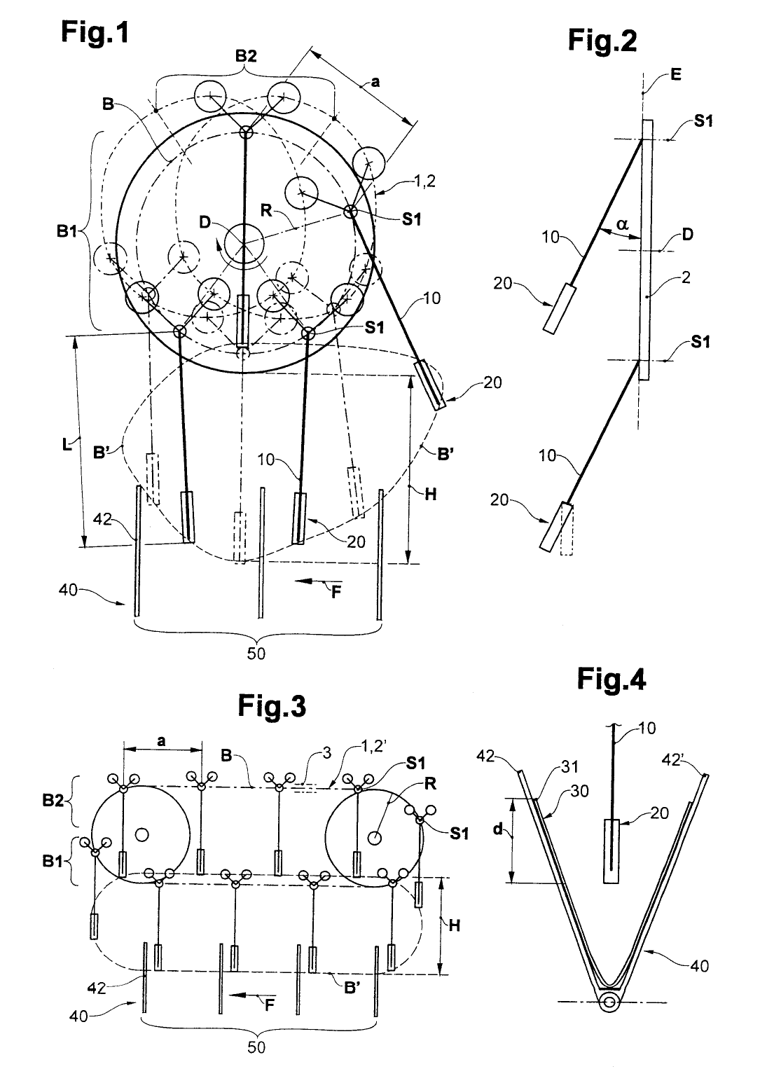

The principle of the invention is sketched in the FIGS. 1 to 3. Levers 10 connected to processing elements are moved along a closed movement path B. The levers 10 thereby are coupled to a drive member 1 in a pivotable manner about first pivot axes 51 or even about 360°. With FIGS. 1 and 2, this member is formed by a rigid body in the form of a wheel 2, with which the levers are pivotably connected at a distance R about the pivot axis 51. The wheel 2 is rotatable about a rotation axis D, with a motor which is not shown here. With FIG. 3, the drive member 1 is a conveyor member 2′, e.g. a chain or a belt, which e.g. runs along guide rails 3 which here are only indicated schematically and is likewise moved with a motor which is not shown here.

With both variants, in each case a plurality of levers 10 are present, whose first pivot axes S1 amongst one another have a constant distance a. It is however possible to use only one lever 10.

The levers are shown at one point in time in FIG. 1 by unbroken lines and at a further point in time in a dashed manner. FIG. 3 only shows a momentary picture.

The movement path of the first pivot axis S1 may be seen as the movement path B of the lever. In FIG. 1 it is circular with a radius R. In FIG. 3, the movement path B comprises two straight and two semicircular sections, the latter likewise with a radius R. The movement path B′ of the processing element 20 is offset thereto. If the orientation of the lever 10 in space on moving along the movement path B remains the same as with FIG. 3, the movement path B′ of the processing element 20 has essentially the same shape as the movement path B of the lever 10. In the case that the orientation in space slightly changes as with FIG. 1, the movement path B′ of the processing element 20 is also slightly deformed with respect to that of the lever 10.

The movement path B of the lever 10 lies in a movement plane E, which here corresponds to the plane of the drawing, and is preferably orientated in a vertical manner. According to the invention, the levers 10 as shown in FIG. 2 are inclined out of this plane E and for example have an angle α of 10° to 80°, preferably 20 to 60° to this. The processing element 20 may likewise have this inclination or be cranked relative to the lever 10 (shown dashed in FIG. 2).

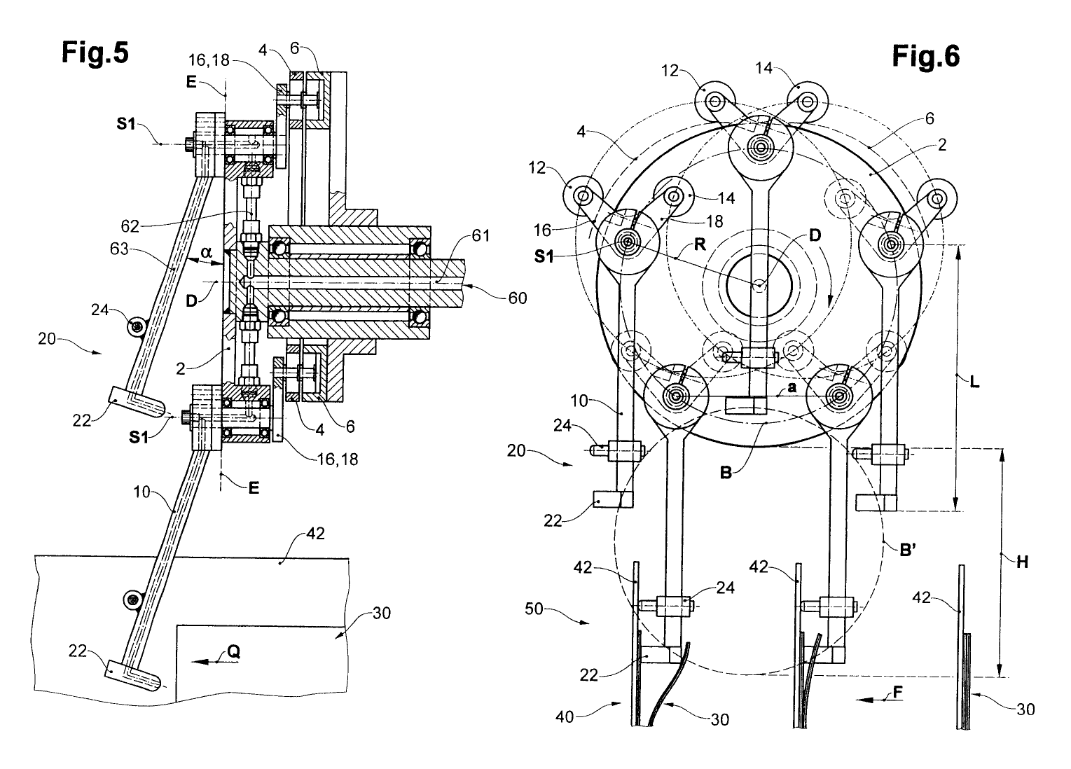

The orientation of the levers 10 relative to their movement path B is controllable by way of a cam control. This here consists of two control cams 4, 6. As shown in more detail in FIGS. 5 and 6, the control cams 4, 6 cooperate in each case with a cam element 12, 14, here in the form of a running roller. These are connected to the lever 10 in each case via a limb 16, 18. The control cams 4, 6 run along the complete movement path B, but it is however also possible for the orientation of the levers 10 to only be controlled over a part of the movement path B.

A conveyor device 40 for products 30 which are not shown here (see FIG. 4), is located in the proximity of the movement path B, here below this. Its conveyor direction F here runs in the horizontal direction tangentially or parallel to the lower part of the movement path B in FIGS. 1 and 3. The conveyer device 40 here comprises a plurality of support surfaces 42, which e.g. are a component of a conveyor pocket or a saddle. A conveyor pocket with a folded and already opened product 30, which is arranged therein, is represented in FIG. 4.

The support surfaces 42 here, merely by way of example, are shown in a position in which they are orientated essentially perpendicularly to the conveyor direction F. Indeed, their orientation in space and relative to the levers 10 may be selected according to the specific demands which are optimal with regard to the processing. For example, the support surfaces 42 in the processing region may be orientated parallel or at a certain angle to the levers 10, wherein the relative position is selected such that the processing element may act on the product 30 in an optimal manner. The conveyor device 40 may, for example, also be a belt conveyor, on which the products lie, or it may move the products along an arcuate path, e.g. as a transport wheel.

The region, in which the processing elements 20 and the conveyor device have approached one another to such an extent that a processing of the products may take place, is indicated at the processing region 50. The conveyor device 40 moves the products 30 preferably with roughly the same speed through the processing region 50, as the processing element 20.

According to the invention, the pivot position of the levers 10 relative to their movement path B is controlled such that the levers in a first part region B1 of the movement path B are orientated outwards relative to this, and in a second part region B2 of the movement path are orientated inwards relative to this, e.g. in FIG. 1 away from the rotation axis D and towards the rotation axis D respectively. The processing region 50 here is located in the first part region B1.

In FIG. 1, the absolute position of the levers 10 in space varies by ±45° with respect to the vertical. In FIG. 3, it is constantly vertical, just as in FIG. 6. Since the drive member 1 is moved in a continuously revolving manner, the levers 10 are freely rotatable with respect to their bearing locations on the drive member 1 (i.e. in the region of their pivot axes 51).

By way of the described control of the pivot position, one succeeds in the levers 10, although pointing to the products 30 in the processing region 50, however during their return through the second part region B2 not projecting to the outside, but being led back in a space-saving manner by way of brushing over the area enclosed by the movement path B. Despite this, the inclination of the levers 10 relative to the movement plane E permits the levers 10 to be relatively long. Here, relatively long means that the lever length L measured between the first pivot axis 51 and the processing element 20 may be larger than the distance “a” of the levers 10 or the first pivot axes 51 to one another. By way of this, one succeeds in the movement path B′ of the processing elements 20 at least in regions, even being completely accessible depending on the lever length L.

In the projection onto the movement plane E, this means that the movement path B', at least in regions, lies outside that region which is assumed by the remaining components of the device, e.g. the wheel 2, the conveyor member 2′, the guide rails 3 and the control cams 4, 6. It runs at a maximal distance H to these components. In the ideal case, this maximal distance may be utilised as a travel executed by the processing element 20.

The upper limit for the travel of the processing element 20 is given by the distance between the upper and the lower part of the movement path B, here thus 2R. This maximal travel may be utilised if the length L of the lever 10 is larger or equal to 2R. The invention permits the use of such long levers 10, without the spatial requirement of the device outside the processing region 50 being increased.

As shown in FIG. 1, the necessary travel may be produced in a spatial region which is relatively small seen in the conveyor direction F and whose width corresponds roughly to the width of the wheel 2. In the case that a longer processing duration is desired, a design as in FIG. 3 is preferably applied.

FIG. 4 shows how a processing element 20 engages deeply into a pocket formed from two support walls 42, 42′, arranged angled to one another, in order to process a folded and already opened product 30. One achieves a processing at a distance d to the front edge 31 of the product 30, which is larger than the distances which have been achieved up to now. The immersion depth which is optimal for the processing may be realised by way of the distance of the wheel 2 to the conveyor device or to the support walls 42, 42′ and/or the lever length L being selected in a suitable manner. The shape of the wheel 2 also has an influence on the achievable immersion depth.

FIGS. 5 and 6 show an opening device for folded products 30, which have the same basic construction as the device from FIGS. 1 and 2. FIG. 5 shows a section perpendicular to the movement plane E and FIG. 6 a plan view of the movement plane E. A wheel 2 serves as a drive member, on which a plurality of here five levers 10 are arranged in a pivotable or rotatable manner about first pivot axes S1 running at a distance to the rotation axis D. The axes S1 have the distance “a” to one another which is the same. The distances “a”, in a variant of the invention which is not shown here, may be varied if the levers are arranged on individual spokes which are rotatable about the rotation axis D or other suitable carrier elements.

The levers 10, or their first pivot axes S1, describe a circular movement path B with a radius R. Their orientation in space is controlled by a cam control with two stationary, here rail-like control cams 4, 6, such that the levers 10 always point in the vertical direction. For this, two control elements 12, 14, here runner rollers, which are coupled to the lever 10 via limbs 16, 18, cooperate with the control cams 4, 6. The two limbs 16, 18 and the respective runner rollers or cams lie in different planes parallel to the movement plane E. The movement path B′ of the processing elements 20 arranged on the levers 10 is likewise a circular path with a radius R. On account of the lever length L, which here almost corresponds to 2R, the largest part of the movement path B′ is freely accessible, which corresponds to a travel H of approximately 2R. Again, a conveyor device 40 of the type already described above, with support surfaces 42 orientated vertically or perpendicularly to the conveyor device F, is located below the wheel 2. Firstly unopened folded and/or multi-layered products 10 which are to be opened with the opening device, lean on these support surfaces.

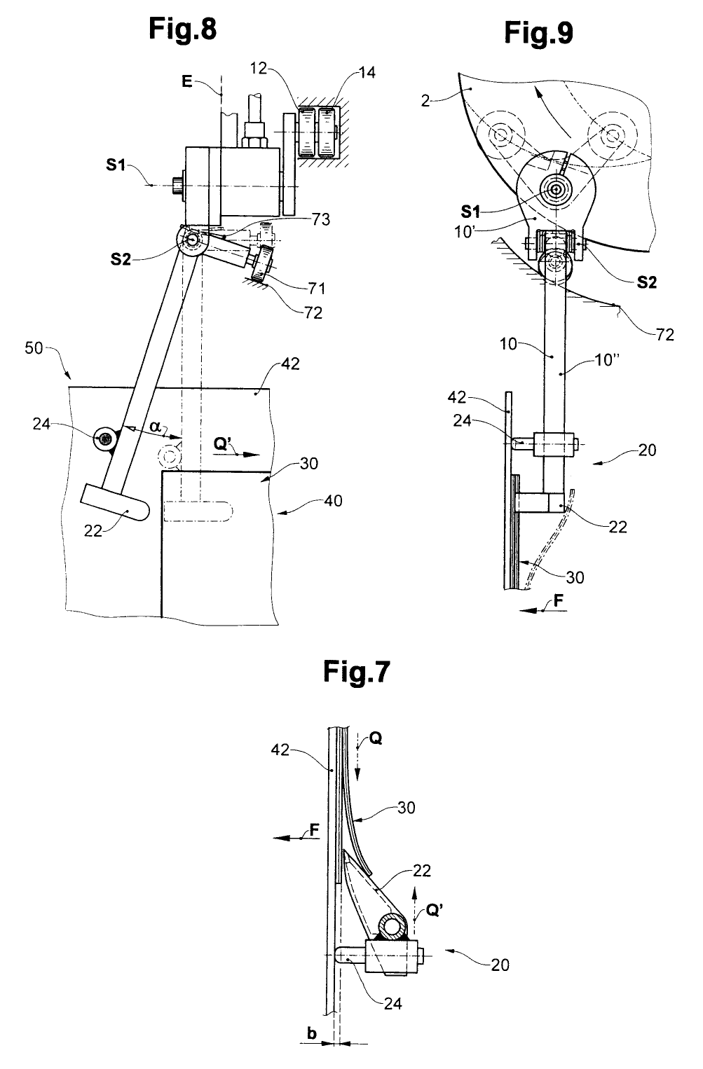

The processing elements 20 here are designed as opening elements and comprise an opening blade 22 and optionally a spacer 24. The spacer 24 points in the conveyor direction F and on processing abuts the support surface 42. By way of this, one ensures that the opening blade travels in between the sides of the product 30 at a well-defined distance b (see FIG. 7) to the support surface 42. The product 30 is opened by way of a displacement of the product 30 and/or the opening blade 22 in the transverse direction Q relative to the conveyor direction F (FIG. 5). The product 30, for example, is displaced relative to the support surfaces 42 with a pusher which is not shown here.

Roughly half of the described displacement H here may be utilised for the processing, since the processing elements 20 move in the upper part of the movement path B′ opposite to the conveyor direction F and must therefore be located outside that region which is covered by the support surfaces 41. Thus, one may move into the conveyor compartments roughly over a stretch corresponding to the radius R, and a corresponding immersion depth may be realised.

Air is blown into the product 30 to be opened via the opening blades 22, in order to simplify the opening procedure. The blow air feed 60 which is envisaged for this, consisting of several bores 61, 62, 63 running along the rotation axis D and through the wheel 2 or through the levers 10, is represented in FIG. 5. One could also bring ink or glue to the processing location in a similar manner.

FIG. 7 shows a detailed view of an opening element on engagement into a product 30, in a view from above onto a product 30 conveyed in a standing manner. The opening is effected by way of displacement of the support surface 43 or of the product 30 in the transverse direction Q and/or by way of displacement of the opening element in the opposite direction Q′. An exactly defined distance b between the front edge of the opening blade 22 and the support surface 42 may be set with the spacer 24.

FIGS. 8 and 9 show an example, as to how, with a device according to FIGS. 5 and 6, with a product which is stationary in the transverse direction Q, i.e. not transversely displaced, a lateral insertion of the opening element in the opposite direction Q′ into the product may be realised. The levers 10 for this are constructed in a two-membered manner with a first lever part 10′ rotatable about the first pivot axis S1, and with a second lever part 10″ connected thereto in a pivotable manner about a second pivot axis S2. The second pivot axis S2 here lies parallel to the movement plane E and is orientated perpendicularly to the first pivot axis S1. A guide element 71 is connected to the second lever part 10″. It cooperates with a control cam 72 and thus serves for setting the pivot position of the second lever part 10″ relative to the first lever part 10′. The first lever part 10′ here lies in or parallel to the movement plane E, but may also be aligned in a different manner. With this, the pivot position of the second lever part 10″ about the second pivot axis S2 determines the inclination angle α of the lever 10 relative to the movement plane E.

This inclination angle α may be varied, and in particular reduced in size, with the control cam 72, in order to introduce the opening element 20 in the processing region 50 laterally into the product 30 by way of a movement in the direction Q′. Outside the processing region 50, the original angle is assumed again, in order to be able to lead back the levers 10 without mutual mechanical hindrance outside the movement pane E.

The control cam 72 may run along the complete movement path B or also only in partial regions thereof. At least in the latter case, a basic position of the lever parts 10′, 10″ relative to one another, and thus the angle α is preset e.g. with a spring 73, and is only changed under the influence of the control cam 72.

1-16. (canceled)

17. A device for processing flat products, in particular printed products, comprising:
at least one lever which is movable by way of a drive member along a closed movement path (B) lying in a movement plane and is pivotable in a controlled manner about a first pivot axis running perpendicularly to the movement plane such that, in a first part region of the movement path, the at least one lever is orientated outwards with respect to this movement path and, in a second part region of the movement path, the at least one lever is orientated inwards with respect to the movement path;
a processing element carried by the at least one lever;
wherein the at least one lever, at least in the second part region of the movement path, is inclined relative to the movement plane.

18. The device according to claim 17, wherein an inclination angle of the at least one lever relative to the movement plan lies between 10 and 80°, preferably between 20 and 60°.

19. The device according to claim 17, further comprising a cam control cooperating with the lever, wherein the cam control serves to set a pivot position of the at least one lever about the first pivot axis.

20. The device according to claim 17, wherein a length of the lever is larger than the smallest radius of curvature of the movement path.

21. The device according to claim 17, wherein a plurality of levers movable along a movement path and processing elements (20) connected to the levers, is present.

22. The device according to claim 21, wherein a length of the levers is larger than a distance of the first pivot axes of two adjacent levers.

23. The device according to claim 17, wherein the drive member comprises at least one rigid body rotatable about a rotation axis, preferably a wheel, or a spoke, to which the at least one lever is pivotably connected at a constant distance to the rotation axis.

24. The device according to claim 17, wherein the drive member is a revolving conveyor member, to which the at least one lever is coupled or to which the at least one lever may be coupled.

25. The device according to claim 17, wherein the lever is pivotable in a controlled manner about a second pivot axis lying in the movement plane or parallel to it.

26. The device according to claim 19, wherein the movement plane is orientated in an essentially vertical manner, and wherein the pivot position of the at least one lever about the first pivot axis is set with the cam control in a manner such that the lever, in the projection onto the movement plane, is orientated essentially in the vertical direction or is orientated in an inclined manner out of the vertical by an angle which in magnitude is smaller than 90°.

27. The device according to claim 17, wherein the processing element comprises at least one of a gripper member, a suction member, an opening element, a welding element and an injection nozzle.

28. The device according to claim 17, wherein the processing element comprises an opening element, as well as a spacer which is distanced thereto, wherein the spacer in the movement direction is capable of setting a defined distance between a support surface for a product, said support surface being moved with the processing element in the case of application, and the opening element.

29. The device according to claim 17, further comprising a conveyor device for the flat products to be processed, which is capable of conveying the flat products in a manner such that the flat products, in a processing region, have at least approximately the same speed and conveyor direction as the at least one processing element.

30. A method for the operation of the device according to claim 17, comprising the steps of:
moving at least one lever, which carries a processing element, along a closed movement path lying in a movement plane;
controlling the pivot position of the at least one lever about a first pivot axis running perpendicularly to the movement plane, in a manner such that the lever in a first part region of the movement path is orientated outwards with respect to this movement path, and in a second part region of the movement path is orientated inwards with respect to this movement path, wherein the lever at least in the second part region of the movement path is inclined relative to the movement plane.

31. A method according to claim 30, further comprising controlling the pivot position of the at least one lever about the first pivot axis such that the lever, during the movement along the movement path in the projection onto the movement plane, is orientated vertically or is orientated inclined out of the vertical by an angle which with regard to magnitude is smaller than 90°.

32. A method according to claim 30, wherein the at least one lever is pivotable about a second pivot axis running in the movement plane and further comprising pivoting the at least one lever in the second part region of the movement path into a position which is inclined relative to the movement plane, and pivoting the at least one lever at least in sections of the first part region of the movement path into a position running in or parallel to the movement plane.
